(19) United States
(12) Patent Application Publication
(10) Pub. No.: US 2008/0094293 A1
(43) Pub. Date: Apr. 24, 2008

(54) Broadband antenna

(75) Inventors: Wei-Shan Chang, Taipei Hsien (TW); Jiunn-Ming Huang, Taipei Hsien (TW)

Correspondence Address: BACON & THOMAS, PLLC, 625 SLATERS LANE, FOURTH FLOOR, ALEXANDRIA, VA, 22314, US

(73) Assignee: WISTRON NEWEB CORP., Taipei Hsien (TW)

(21) Appl. No.: 11/905,009

(22) Filed: Sep. 27, 2007

(30) Foreign Application Priority Data
Oct. 20, 2006 (TW) 095218592

(51) Int. Cl. H01Q 1/22

(52) U.S. Cl. 343/702

(57) ABSTRACT

A broadband antenna comprises a radiating element, a grounding element, a connecting element and a parasitic element. The connecting element comprises a first end and a second end. The first end of the connecting element is electrically connected to the radiating element, and the second end is electrically connected to the grounding element. The broadband antenna has a three dimensional structure which can reduce the entire volume. The radiating element extends extra radiation area; therefore, the broadband antenna has larger frequency bandwidth and better radiation characteristic.

### BACKGROUND OF THE INVENTION

1. Field of the Invention

The present invention relates to an antenna, and more particularly, to a broadband antenna with extra radiation area and three-dimensional structure.

2. Description of the Related Art

With the developments in wireless communications technology, many electronic devices, such as notebooks and mobile phones, now incorporate wireless communications technologies, such as wireless wide area network (WWAN) technologies. To receive and transmit signals, these electronic devices need antennas for detecting electromagnetic radiation.

The prior art technology discloses a type of broadband antenna. Please refer to FIG. 1A. In R.O.C patent application No. 95119253, a planar antenna 90 has a radiating element 91, a connecting element 92 and a grounding element 93. The connecting element 92 has a first end 921 and a second end 922. The first end 921 of the connecting element 92 is connected to the radiating element 91, and the second end 922 is connected to the grounding element 93. The prior art antenna 90 further comprises a parasitic element 94 for increasing its bandwidth. Please refer to FIG. 1B. FIG. 1B is a schematic drawing showing a voltage standing wave ratio (VSWR) according to FIG. 1A.

In the various wireless communication fields, multiple standards coexist. However, with the trend towards miniaturization in electronic devices, these antennas are subject to smaller size requirements to accommodate these limited spaces, but must continue to provide satisfactory impedance bandwidth and antenna characteristics.

Therefore, it is desirable to provide a broadband antenna to mitigate and/or obviate the aforementioned problems.

### SUMMARY OF THE INVENTION

A main objective of the present invention is to provide a broadband antenna, which has smaller volume and larger frequency bandwidth.

In order to achieve the above-mentioned objective, the broadband antenna is applied in a portable device. The broadband antenna comprises a radiating element, a grounding element, a connecting element and a parasitic element. The radiating element comprises a first radiation area, a second radiation area and a third radiation area. The connecting element comprises a first end and a second end. The grounding element comprises a first panel and a second panel. The first end of the connecting element is electrically connected to the second radiation area of the radiating element, and the second end is electrically connected to the first panel of the grounding element. The first radiation area and the second radiation area are vertically adjacent to each other, and the second end of the connecting element and the first panel of the grounding element are vertically adjacent to each other. The connecting element further comprises a feeding point, and the current signal between the radiating element and a wireless signal module is sent via the feeding line from the feeding point. A bending line is located between the first panel and the second panel of the grounding element, so the first panel and the second panel are vertically adjacent to each other.

The parasitic element extends from the end of the second end to increase the frequency bandwidth of the broadband antenna. The third radiation area also extends from the radiating element. The third radiation area and the first radiation area are vertically adjacent to each other. Therefore, the broadband antenna has larger frequency bandwidth and better radiation characteristic.

The broadband antenna may be mounted in a portable device, with the feeding point electrically connected to a feeding line that is connected to a wireless signal module. The portable device can thus receive or transmit wireless signals via the broadband antenna.

Other objects, advantages, and novel features of the invention will become more apparent from the following detailed description when taken in conjunction with the accompanying drawings.

### BRIEF DESCRIPTION OF THE DRAWINGS

FIG. 1A illustrates a prior art antenna.

FIG. 1B shows a voltage standing wave ratio according to FIG. 1A.

FIG. 2A is a perspective view of a broadband antenna according to the present invention.

FIG. 2B is a front view of a broadband antenna according to the present invention.

FIG. 2C is schematic drawing showing a voltage standing wave according to FIG. 2A.

FIG. 3 is a functional block drawing according to the present invention.

### DETAILED DESCRIPTION OF THE PREFERRED EMBODIMENT

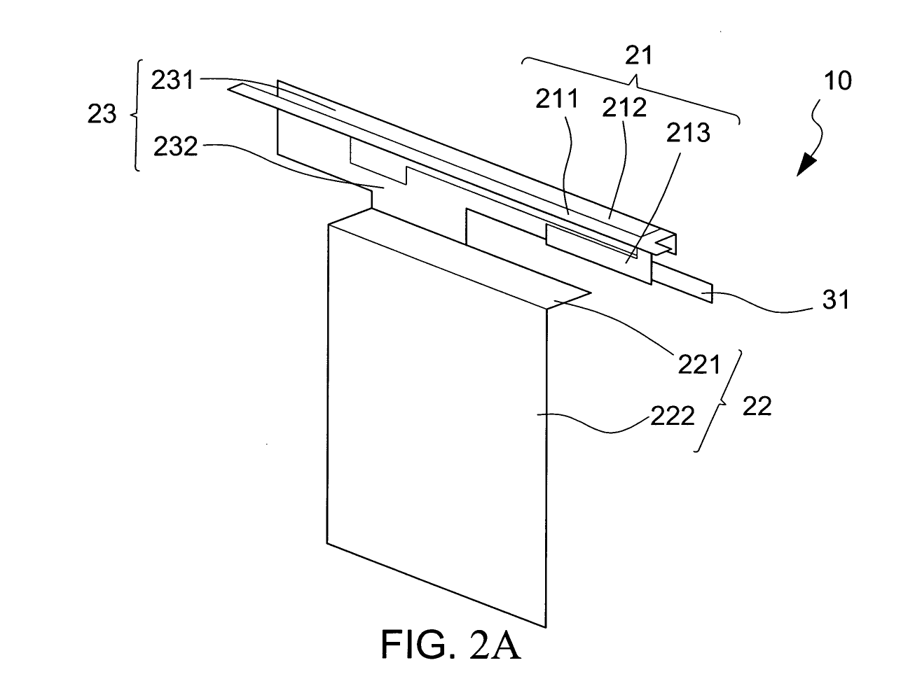

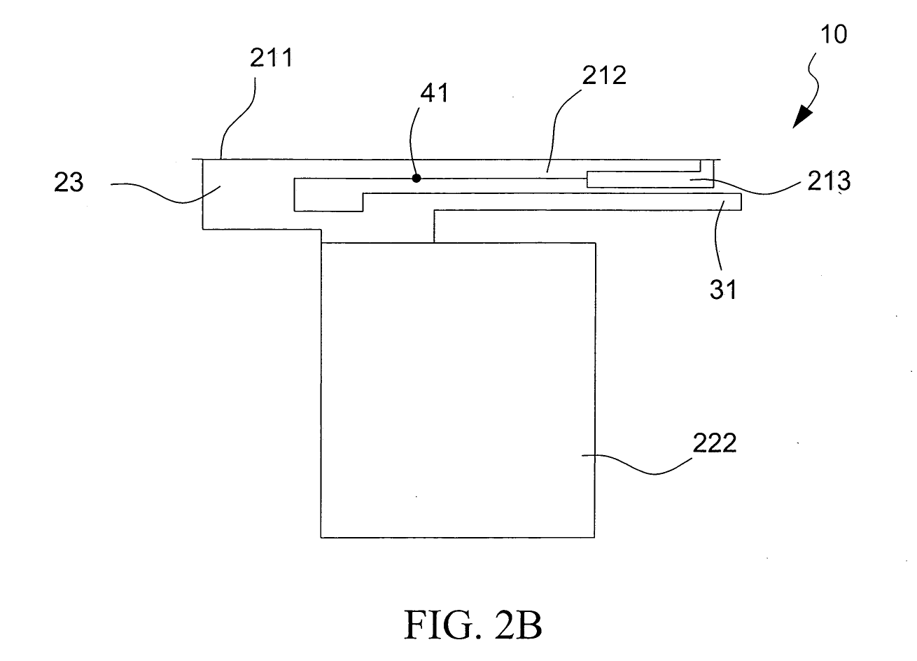

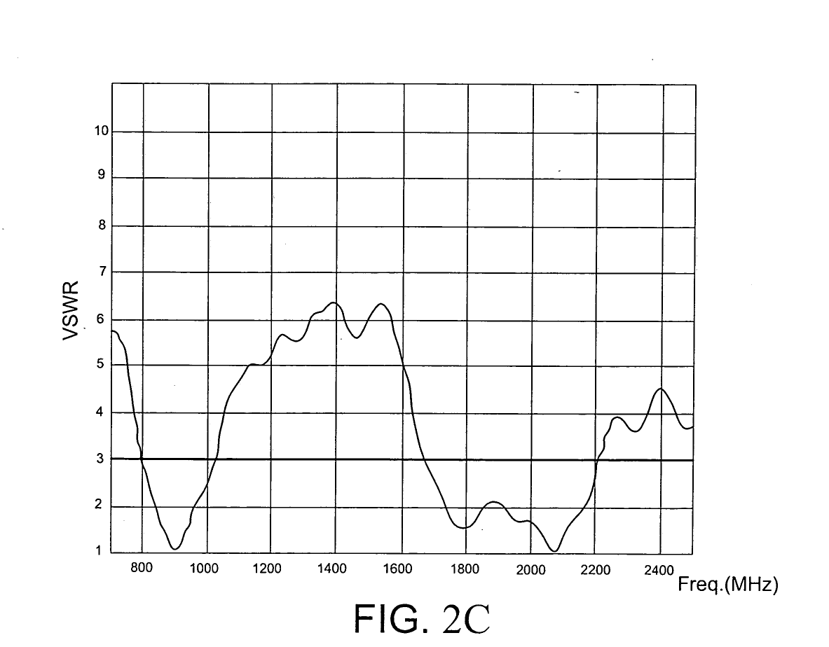

Please refer to FIGS. 2A˜2B. FIG. 2A is a perspective view of a broadband antenna according to the present invention. FIG. 2B is a front view of the broadband antenna according to the present invention.

A broadband antenna 10 of the present invention may be used in a portable device for wireless transmissions, such as for a Wireless Wide Area Network (WWAN). The portable device may be a notebook computer, a mobile phone, a PDA, etc. The broadband antenna 10 is preferably made of metal having good conductivity, such as a copper alloy or other metal.

The broadband antenna 10 comprises a radiating element 21, a grounding element 22, a connecting element 23 and a parasitic element 31. The radiating element 21 comprises a first radiation area 211, a second radiation area 212 and a third radiation area 213. The first radiation area 211 and the second radiation area 212 are perpendicularly adjacent to each other; the first radiation area 211 and the third radiation area 213 are perpendicularly adjacent to each other. The connecting element 23 comprises a first end 231 and a second end 232. The grounding element 22 comprises a first panel 221 and a second panel 222. The radiating element 21 is made of a metal plate; when fed a current, the radiating element 21 can radiate energy via charge carrier excitement. The first end 231 of the connecting element 23 is electrically connected to the second radiation area 212 of the radiating element 21, and the second end 232 is electrically connected to the first panel 221 of the grounding element 22. The second end 232 and the first panel 221 are perpendicularly adjacent to each other. A bending line is located between the first panel 221 and the second panel 222 of the grounding element 22, so that the first panel 221 and the second panel 222 are vertically adjacent to each other. Besides, surface of the first panel 221 is smaller than surface of the second panel 222. The connecting element 23 further comprises a feeding point 41, and the feeding point 41 is electrically connected to a feeding line (not shown). The current signal between the radiating element 21 and a wireless signal module is sent via the feeding line from the feeding point 41. With the above mentioned structure, the broadband antenna 10 is able to reduce the height from the radiating element 21 to the grounding element 22, and thus provides a smaller volume.

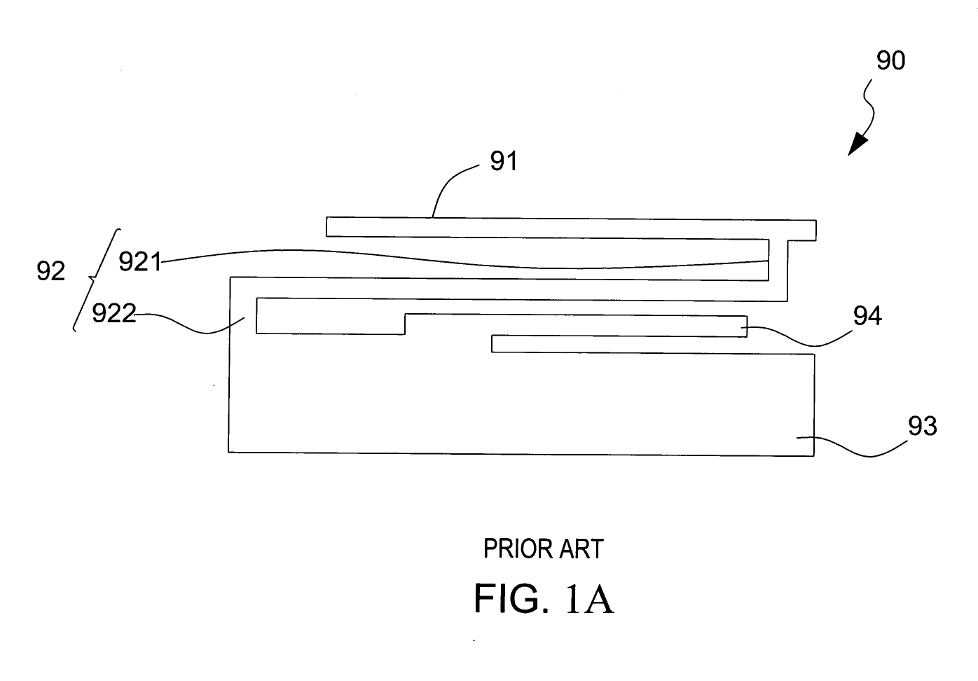

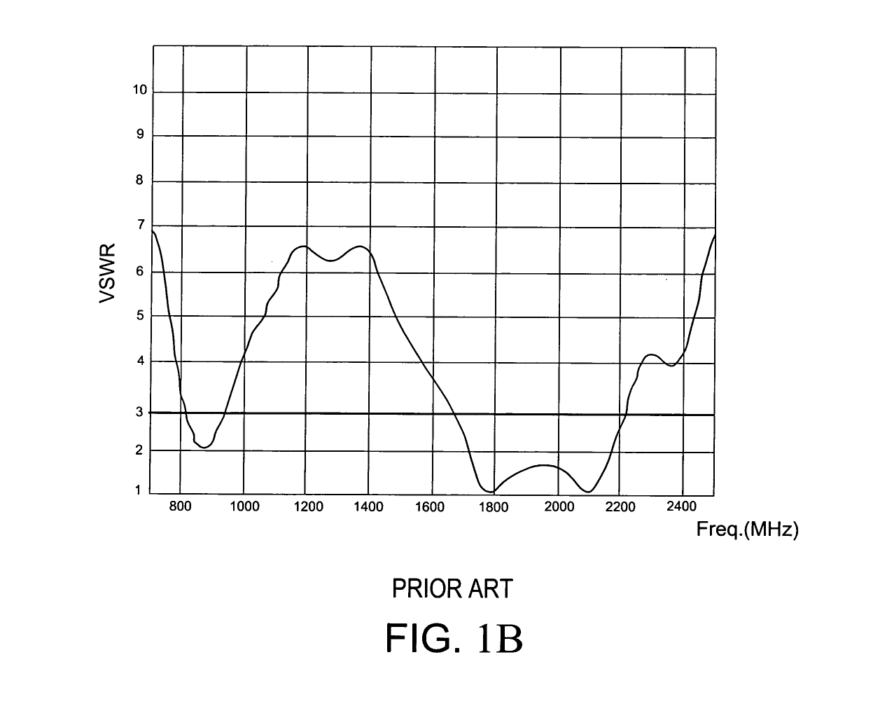

The parasitic element 31 in the broadband antenna 10 is a long metal plate strip, which is placed at the end of the second end 232, and which increases the bandwidth of the broadband antenna 10. In contrast to the prior art, the third radiation area 213 further extends from the radiating element 21. The third radiation area 213 is an L-shaped metal plate. The first radiation area 211 and the third radiation area 213 are perpendicularly adjacent to each other; therefore, the parasitic element 31 and the third radiation area 213 are parallel with each other. The broadband antenna 10 can use the length of the parasitic element 31 to control the bandwidth frequency range, which permits the broadband antenna 10 to improve the frequency bandwidth at high frequencies. In the present invention, the first radiation area 211 and the second radiation area 212 of the radiating element 21 can transmit wireless signals in the 900 MHz range. The third radiation area 213 and the second radiation area 212 of the radiating element 21 utilize the end of the first radiation area 211 to transmit wireless signals in the 1800 MHz range. The parasitic element 31 can transmit wireless signals in the 2100 MHz range. With the structure provided by the broadband antenna 10 and the third radiation area 213, the broadband antenna 10 has a better frequency bandwidth and radiation characteristics than the prior art antenna 90. The voltage standing wave ratio of the broadband antenna 10 is shown in FIG. 2C. When the voltage standing wave ratio (VSWR) of the broadband antenna 10 is less than 3, the low frequency range is about 0.8 GHz to 1.0 GHz, and the high frequency range is about 1.7 GHz to 2.2 GHz. In comparison to the frequency bandwidth of the prior art antenna 90 as shown in FIG. 1B, the frequency bandwidth of the broadband antenna 10 is increased.

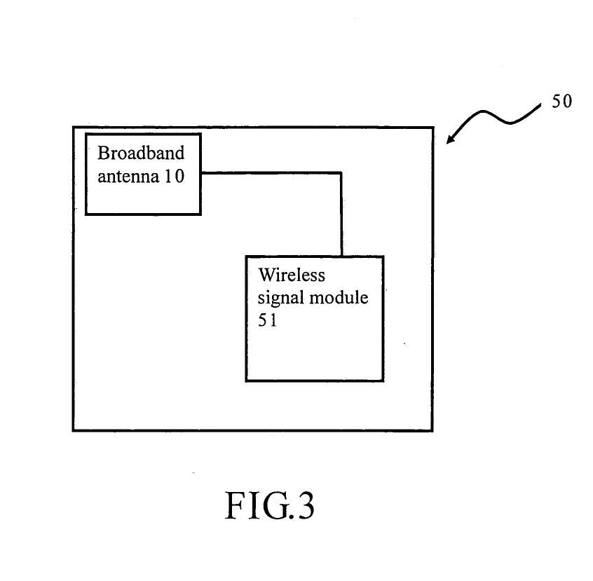

Finally, as shown in FIG. 3, the broadband antenna 10 may be mounted in a portable device 50, with the feeding point 41 electrically connected to a feeding line that is connected to a wireless signal module 51. The portable device 50 can thus receive or transmit wireless signals via the broadband antenna 10.

Although the present invention has been explained in relation to its preferred embodiment, it is to be understood that many other possible modifications and variations can be made without departing from the spirit and scope of the invention as hereinafter claimed.

What is claimed is:

1. A broadband antenna for a portable device comprising:
a radiating element having a first radiation area, a second radiation area and a third radiation area, wherein the first radiation area is perpendicularly connected to the second radiation area and the first radiation area is connected to the third radiation area;
a grounding element; and
a connecting element having a first end and a second end, wherein the first end is connected to the second radiation area, and the second end is electrically connected to the grounding element; and
a parasitic element connected to the second end.

2. The broadband antenna as claimed in claim 1, wherein the portable device is a notebook computer, a mobile phone or a PDA.

3. The broadband antenna as claimed in claim 1, wherein the grounding element further comprises a first panel and a second panel.

4. The broadband antenna as claimed in claim 3, wherein the first panel and the second panel are perpendicularly connected together.

5. The broadband antenna as claimed in claim 1, wherein the connecting element further comprises a feeding point.

6. The broadband antenna as claimed in claim 1, wherein the third radiation area and the parasitic element are parallel with each other.

7. The broadband antenna as claimed in claim 1, wherein the first radiation area and the third radiation area are perpendicular to each other.

8. A portable device comprising a broadband antenna, the broadband antenna comprising:
a radiating element having a first radiation area, a second radiation area and a third radiation area, wherein the first radiation area is perpendicularly connected to the second radiation area and the first radiation area is connected to the third radiation area;
a grounding element; and
a connecting element having a first end and a second end, wherein the first end is connected to the second radiation area, and the second end is electrically connected to the grounding element; and
a parasitic element connected to the second end.

9. The portable device as claimed in claim 8, wherein the portable device is a notebook computer, a mobile phone or a PDA.

10. The portable device as claimed in claim 8, wherein the grounding element further comprises a first panel and a second panel.

11. The portable device as claimed in claim 10, wherein the first panel and the second panel are perpendicularly connected together.

12. The portable device as claimed in claim 8, wherein the connecting element further comprises a feeding point.

13. The portable device as claimed in claim 8, wherein the third radiation area and the parasitic element are parallel with each other.

14. The portable device as claimed in claim 8, wherein the first radiation area and the third radiation area are perpendicular to each other.
